(19) United States
(12) Patent Application Publication
(10) Pub. No.: US 2014/0279095 A1
(43) Pub. Date: Sep. 18, 2014

(54) SOCIAL COMMERCE SYSTEM

(71) Applicant: LE METIER DE BEAUTE, New York, NY (US)

(72) Inventors: Richard Blanch, Hopewell Junction, NY (US); Daniel S. Robey, Falls Church, VA (US)

(73) Assignee: LE METIER DE BEAUTE, New York, NY (US)

(21) Appl. No.: 13/838,096

(22) Filed: Mar. 15, 2013

(51) Int. Cl. G06Q 20/12; G06Q 30/06

(52) U.S. Cl. CPC G06Q 20/12; G06Q 30/0641
USPC 705/16

(57) ABSTRACT

A system and method for selecting a product by facilitating the interaction between a customer and an agent at a point of sale. The system and method allows for the modification of an in store database and facilitates identification of desired in store products and assets and allows for comparisons between pre-identified customer products and assets with products and assets in the store database.

### FIELD OF INVENTION

The invention of the current application relates to a social commerce system which enables a synergistic relationship between web based consumerism including social media, internet marketing and online shopping and a traditional in-store shopping experience.

Traditionally customers must choose between an in-store shopping experience or an online shopping experience. The extent in overlap between the two has largely been limited to online promotion of in-store items and accessing information regarding in-store products on the internet via posted web address or displayed QR codes. More commonly, store owners end up competing with their own web based affiliates for customers. This lack of a cohesive relationship between shopping experiences has resulted in consumers choosing one over the other and has effectively bisected the consumer population into online shoppers and in-store shoppers.

The invention of the current application fills the need for a synergistic online and in-store shopping experience by providing a system which integrates the fast and flexible access of product data provided by the internet with the less tangible data gathered by a customer experimenting with a product in a store with the help and advice of an experience sales associate.

### SUMMARY OF THE INVENTION

For the purposes of this application the following terms should be understood as defined below:

“Administrator” shall mean a System User that is an individual that uses the Administrator Subsystem and is an affiliate of a Retailer.

“Administrator Subsystem” shall mean software implemented through the Standard Administrator Subsystem Embodiment that provides certain functionality to Agents by organizing the product database.

“Administrator Input” shall mean any input made by and Administrator as a part of the Administrator Subsystem.

“Agent” shall mean a System User that is an individual that uses the Agent Subsystem and is an affiliate of a Retailer.

“Agent Subsystem” shall mean software implemented through the Standard Agent Subsystem Embodiment or Mobile Agent Subsystem Embodiment that provides certain functionality to Agents.

“Agent Input” shall mean any input made by an Agent as a part of any of the Subsystems of the System.

“Asset” shall mean an image, audio clip, video or other document or media file that can be displayed or presented on a computing device.

“Asset Descriptor” shall mean text used to describe an Asset.

“Board” shall mean a named group of Assets that are sourced from Collections and spatially organized in a non-linear fashion, for example as with a collage of images, with associated Tags and Asset Descriptors.

“Collection” shall mean a named, ordered group of Assets with associated Tags and Asset Descriptors.

“Customer” shall mean a System User that is an individual that uses the Customer Subsystem.

“Customer Subsystem” shall mean software implemented through the Customer Subsystem Browser Embodiment or Customer Subsystem Mobile Embodiment that provides certain functionality to Customers.

“Customer Input” shall mean any input made by a Customer as a part of any of the Subsystems of the System.

“Keyword” shall mean text associated with a Product.

“Large Format Agent Subsystem Embodiment” shall mean an embodiment of the Agent Subsystem that allows use of the Agent Subsystem on computing devices attached to large display devices that typically support touch interactions.

“Mobile Agent Subsystem Embodiment” shall mean an embodiment of the Agent Subsystem designed specifically for use of the Agent Subsystem on small display screens such as can typically be found in mobile computing devices, and using input and interaction means suited to mobile computing devices, such as touch-based input. For example, an Agent could operate the Mobile Agent Subsystem Embodiment using a smartphone.

“Mobile Customer Subsystem Embodiment” shall mean an embodiment of the Customer Subsystem designed specifically for use of the Customer Subsystem on small display screens such as can typically be found in mobile computing devices, and using input and interaction means suited to mobile computing devices, such as touch-based input. For example, a Customer could operate the Mobile Customer Subsystem Embodiment using a smartphone.

“Product” shall mean a good or service sold by a Retailer. Each Product is defined in the System by a name, one or more Assets, one or more Keywords and optionally a hyperlink to purchase such Product through an online e-commerce system.

“Product Database” shall mean the products of a particular Store where the System is located and which the System has access to. This is distinguishable from a company website in that the product database is limited to those Products and Assets at a store.

“Retailer” shall mean an organization that sells Products and employs Agents and Administrators.

“Retailer Collection” shall mean a type Collection created by an Administrator using the Administrator Subsystem designed to present Products offered by a Retailer where rather than containing Assets and associated data, the Collection contains Products and associated data.

“Standard Administrator Subsystem Embodiment” shall mean an embodiment of the Administrator Subsystem that allows use of the Administrator Subsystem on computing devices without specific regard to display screen size or user input and interaction means. For example, an Administrator could operate the Standard Administrator Subsystem Embodiment using a desktop personal computer, a tablet computing device or a laptop computer.

“Standard Agent Subsystem Embodiment” shall mean an embodiment of the Agent Subsystem that allows use of the Agent Subsystem on computing devices without specific regard to display screen size or user input and interaction means. For example, an Agent could operate the Standard Agent Subsystem Embodiment using a desktop personal computer, a tablet computing device or a laptop computer.

“Standard Customer Subsystem Embodiment” shall mean an embodiment of the Customer Subsystem that allows use of the Customer Subsystem on computing devices without specific regard to display screen size or user input and interaction means. For example, a Customer could operate the Standard Customer Subsystem Embodiment using a desktop personal computer, a tablet computing device or a laptop computer.

“Store” shall mean a specific point of sale location.

“System” shall mean the system or method of the application.

“System User” shall mean a user of the System, which user may be an Agent, Customer or Administrator.

“Tag” shall mean a short text term, usually a single word or abbreviation and often prefixed with the hash (“#”) character.

“Wish List” shall mean the one list of Products created by a Customer using the Customer Subsystem.

### Administrator Subsystem

In the preferred embodiment (also referred to as the Standard Administrator Subsystem), the Administrator Subsystem allows Administrators to:

(1) Create, update, delete and view Retailer Collections; and

(2) Manage Product data.

The Administrator Subsystem allows for the following functions:

### Create Retailer Collection

To create a Retailer Collection, an Administrator initiates the Retailer Collection creation process, for example by clicking a button, then inputs a name for the newly-created Retailer Collection.

### Edit Retailer Collection

An Administrator may add, edit or delete Products and reorder Products. These actions are effectuated using standard user interface techniques, such as text entry, control interaction (e.g., button clicking), dragging, etc.

### Delete Retailer Collection

To delete a Retailer Collection, an Administrator initiates the Retailer Collection deletion process, for example by clicking a button. Upon doing so, the Retailer Collection is removed from the Administrator Subsystem. However, if the same Products appear in other Collections, these Products will remain in such other Collections.

View Retailer Collection

An Administrator may select and view a Retailer Collection using standard user interface techniques, such as text entry, control interaction (e.g., button clicking), dragging, etc. When viewing a Retailer Collection, an Administrator primarily views/interacts with Products within such Retailer Collection.

Add Product to Retailer Collection

To add a Product to a Retailer Collection, an Administrator locates such Product in the Retailer's inventory management system (i.e., a service not included in the System), then initiates the Product acquisition process, for example by clicking a button. Upon doing so, the Product is added to the Retailer Collection designated by the Administrator. By default, each new Product is added to a Retailer Collection after the last most recently added Product. Adding a Product to a Retailer Collection requires interoperability between the Administrator Subsystem and a Retailer's inventory management system.

### Manage Product Data

With respect to each Product, Administrators assign a name, one or more Assets, one or more Keywords and optionally a hyperlink to purchase such Product through an online e-commerce system. These actions are effectuated using standard user interface techniques, such as text entry, control interaction (e.g., button clicking), dragging, etc.

### Agent Subsystem

The Agent Subsystem has three preferred embodiments: the Standard Agent Subsystem Embodiment, the Large Format Agent Subsystem Embodiment and the Mobile Agent Subsystem Embodiment.

Various embodiments of the Agent Subsystem allow for the following functions which allow Agents to:
(1) Create, update, delete and view Collections;
(2) Publish Collections to third-party social networks such as FACEBOOK for the purpose of sharing Collections with others;
(3) Create, update, delete and view Boards;
(4) Publish Boards to third-party social networks such as FACEBOOK for the purpose of sharing Boards with others;
(5) Assist Customers in the collaborative creation of Customer Boards; and
(6) Identify Products for Customers and assist Customers with purchasing such Products.
(7) Publish Boards to third-party social networks such as FACEBOOK for the purpose of sharing Boards with others.

Standard Agent Subsystem

In the preferred embodiment of the Standard Agent Subsystem, the Standard Agent Subsystem allows for the following functions:

### Create Collection

To create a Collection, an Agent initiates the Collection creation process, for example by clicking a button or selecting a field, then inputting a name for the newly-created Collection. The Agent may also optionally input any number of Tags to further define the Collection.

Import Collection from Third Party Originator

To import a Collection, an Agent identifies a comparable data structure administered and/or hosted by a third party service, such as a FACEBOOK album, a PINTEREST pinboard, an ITUNES playlist, a YOUTUBE playlist or FLICKR album, that such Agent has access rights to then initiates the Collection import process, for example by clicking a button. Upon doing so, data items associable with Collection name, Assets, Tags and Asset Descriptors are associated with these Collection structures, respectively. Importing a Collection requires interoperability between the Agent Subsystem and a third party network following the connection means made available by such third party network and requiring Agent approvals and inputs as necessary to effectuate the transfer of data.

Bookmark Shared Collection

Shared Collections that appear on third party networks include hyperlinks encoded in HTML. If a first Agent follows a hyperlink from a third party network included with the shared Collection of a second Agent or Customer, the first Agent will have the option of “bookmarking” such shared Collection of the second Agent or Customer such that the first Agent can view the second Agent's or Customer's Collection from within the Agent Subsystem as it appears to the first Agent (i.e., as if the Collection had been created by the first Agent). Access rights to such Collection with respect to the first Agent is limited to viewing only. If the second Agent or Customer deletes such Collection, the Collection will be removed from the first Agent's Agent Subsystem unless the first Agent elects to create a new Collection and copy all Assets into such Collection upon being prompted with the option to do so.

### Edit Collection

An Agent may add, edit or delete Assets and Tags and reorder Assets. These actions are effectuated using standard user interface techniques, such as text entry, control interaction (e.g., button clicking), dragging, etc.

### Delete Collection

To delete a Collection, an Agent initiates the Collection deletion process, for example by clicking a button. Upon doing so, the Collection and its Assets are removed from the Agent Subsystem. However, if the same Assets appear in other Collections, these Assets will remain in such other Collections.

### View Collection

An Agent may select and view a Collection using standard user interface techniques, such as text entry, control interaction (e.g., button clicking), dragging, etc. When viewing a Collection, an Agent primarily views/interacts with Assets within such Collection.

### Share Collection

To publish a Collection to a third party network such as FACEBOOK, thereby sharing the contents of the Collection with other individuals, an Agent initiates the Collection publication process, for example by clicking a button. Upon doing so, the Collection, including its name, Tags, Assets and Asset Descriptors, is published to a third party network. Publishing a Collection requires interoperability between the Agent Subsystem and a third party network following the connection means made available by such third party network and requiring Agent approvals and inputs as necessary to effectuate the transfer of data.

### Create Board

To create a Board, an Agent initiates the Board creation process, for example by clicking a button, then inputs a name for the newly-created Board. The Agent may also optionally input any number of Tags to further define the Board.

### Edit Board

An Agent may add, edit or delete Assets and Tags and rearrange Assets. These actions are effectuated using standard user interface techniques, such as text entry, control interaction (e.g., button clicking), dragging, etc.

### Delete Board

To delete a Board, an Agent initiates the Board deletion process, for example by clicking a button. Upon doing so, the Board is removed from the Agent Subsystem.

### View Board

An Agent may select and view a Board using standard user interface techniques, such as text entry, control interaction (e.g., button clicking), dragging, etc.

### Share Board

To publish a Board to a third party network such as FACEBOOK, thereby sharing the contents of the Board with other individuals, an Agent initiates the Board publication process, for example by clicking a button. Upon doing so, the Board, including its name, Tags, Assets and Asset Descriptors, is published to a third party network. Publishing a Board requires interoperability between the Agent Subsystem and a third party network following the connection means made available by such third party network and requiring Agent approvals and inputs as necessary to effectuate the transfer of data.

Add Asset to Collection from External Source

To add an Asset to a Collection, an Agent locates an Asset that is either locally available on the device used to operate the Standard Agent Subsystem Embodiment or available over a network, including the Internet, then initiates the Asset acquisition process, for example by clicking a button. Upon doing so, the Asset is added to the Collection designated by the Agent. By default, each new Asset is added to a Collection after the last most recently added Asset.

Copy Asset from Collection

To add an Asset to a Collection when that Asset already exists in another Collection, an Agent locates the Asset in such other Collection, then initiates the Asset copy process, for example by clicking a button. Upon doing so, a copy of the Asset and any associated Asset Descriptors is added to the Collection designated by the Agent. By default, each copied Asset is added to a Collection after the last most recently added Asset.

### Bulk Import of Assets to Collection

To import more than one Asset into a Collection at a time, an Agent identifies a data structure administered and/or hosted by a third party service, such as a FACEBOOK album, a PINTEREST pinboard, an ITUNES playlist, a YOUTUBE playlist or FLICKR album, that contains Assets and that such Agent has access rights to then initiates the Asset import process, for example by clicking a button. Upon doing so, data items associable with Assets and Asset Descriptors are associated with these Asset structures, respectively. Importing Assets requires interoperability between the Agent Subsystem and a third party network following the connection means made available by such third party network and requiring Agent approvals and inputs as necessary to effectuate the transfer of data.

### Add Asset to Board

To add an Asset to a Board an Agent first locates the Asset in a Collection then initiates the Asset copy process, for example by clicking a button. Upon doing so, a copy of the Asset and any associated Asset Descriptors is added to the Board designated by the Agent. Once added to the Board, the Agent may modify the location of the Asset on the Board.

### Edit Asset

An Agent may add, edit or delete Asset Descriptors. These actions are effectuated using standard user interface techniques, such as text entry, control interaction (e.g., button clicking), dragging, etc. These actions only affect the copy of an Asset associated with the Board or Collection through which it is accessed. Other copies of an edited Asset are not affected.

### Delete Asset

To delete an Asset, an Agent initiates the Asset deletion process, for example by clicking a button. Upon doing so, the Asset is removed from its Collection. This action only affects the copy of an Asset associated with the Board or Collection through which it is accessed. Other copies of a deleted Asset are not affected.

### Share Asset

To publish an Asset to a third party network such as FACEBOOK, thereby sharing the Asset with other individuals, an Agent initiates the Asset publication process, for example by clicking a button. Upon doing so, the Asset, including its Asset Descriptors, is published to a third party network. Publishing an Asset requires interoperability between the Agent Subsystem and a third party network following the connection means made available by such third party network and requiring Agent approvals and inputs as necessary to effectuate the transfer of data.

### Add Asset Descriptors

An Agent may optionally input one or more Asset Descriptors to name or identify an Asset.

Associate Asset Descriptors with Regions of Image Assets

When the Asset is an image, an Agent may associate an Asset Descriptor to a region of that image by using available input means to designate such region, for example using the drag gesture with a mouse to mark a rectangular area of the image.

Associate Asset Descriptors with Identified Objects within Image Assets

When the Asset is an image, the Agent Subsystem may automatically identify objects within the Asset by circumscribing identified objects in a manner that visually highlights these objects and providing an Asset Descriptor for each such object. The Agent may accept, edit or delete such Asset Descriptors.

### Edit Asset Descriptor

An Agent may edit or delete an Asset Descriptor. These actions are effectuated using standard user interface techniques, such as text entry, control interaction (e.g., button clicking), dragging, etc.

### Delete Asset Descriptor

To delete an Asset Descriptor, an Agent initiates the Asset Descriptor deletion process, for example by clicking a button. Upon doing so, the Asset Descriptor is removed from its Asset.

### Share Asset

To publish an Asset to a third party network such as FACEBOOK, thereby sharing the Asset and associated Asset Descriptors with other individuals, an Agent initiates the Asset publication process, for example by clicking a button. Upon doing so, the Asset, including its Asset Descriptors, is published to a third party network. Publishing an Asset requires interoperability between the Agent Subsystem and a third party network following the connection means made available by such third party network and requiring Agent approvals and inputs as necessary to effectuate the transfer of data.

### Display Products for Collection

An Agent can navigate from a Collection, for example by clicking a button, to a list displaying Products that are determined by the Agent Subsystem to be related to such Collection. Such determination is made by comparing Tags and Asset Descriptors with information associated with Products. A Product may so be displayed by virtue of: (i) the name of, or Keywords associated with such, Product matching the content or meaning (as determined by the System) of one or more Tags or Asset Descriptors; (ii) the name of, or Keywords associated with such, Product being complementary to the content or meaning (as determined by the System) of one or more Tags or Asset Descriptors; or (iii) any other association or associations made by an Administrator using the Administrator Subsystem between such Product and Keywords entered by such Administrator that match the content or meaning (as determined by the System) of one or more Tags or Asset Descriptors.

### Display Products for Board

An Agent can navigate from a Board, for example by clicking a button, to a list displaying Products that are determined by the Agent Subsystem to be related to such Board. Such determination is made by comparing Tags and Asset Descriptors with information associated with Products. A Product may so be displayed by virtue of: (i) the name of, or Keywords associated with such, Product matching the content or meaning (as determined by the System) of one or more Tags or Asset Descriptors; (ii) the name of, or Keywords associated with such, Product being complementary to the content or meaning (as determined by the System) of one or more Tags or Asset Descriptors; or (iii) any other association or associations made by an Administrator using the Administrator Subsystem between such Product and Keywords entered by such Administrator that match the content or meaning (as determined by the System) of one or more Tags or Asset Descriptors.

### Display Products for Asset

When viewing/interacting with an Asset within a. Collection or Board, an Agent can navigate from such Asset, for example by clicking a button, to a list displaying Products that are determined by the Agent Subsystem to be related to such Asset. Such determination is made by comparing Asset Descriptors with information associated with Products. A Product may so be displayed by virtue of: (i) the name of, or Keywords associated with such, Product matching the content or meaning (as determined by the System) of one or more Asset Descriptors; (ii) the name of, or Keywords associated with such, Product being complementary to the content or meaning (as determined by the System) of one or more Asset Descriptors; or (iii) any other association or associations made by an Administrator using the Administrator Subsystem between such Product and keywords entered by such Administrator that match the content or meaning (as determined by the System) of one or more Asset Descriptors.

### Large Format Agent Subsystem Embodiment

The Large Format Agent Subsystem Embodiment allows for both a Customer and an Agent to access certain functionality of the Agent Subsystem collaboratively. In its preferred embodiment, the Large Format Agent Subsystem provides the following advantages:

(i) to allow an Agent to assist a Customer in the creation of a Board saved to the Customer's account; and (ii) to allow an Agent to share Collections, Boards and Assets with the Customer. In this capacity, Boards serve as Product and/or idea dossiers. The working area of the Large Format Agent Subsystem Embodiment is large enough to allow three distinct regions of operation: (i) a region for the logged-in Customer that displays and provides access to such Customer's Collections, Boards and Assets; (ii) a region for the logged in Agent that displays and provides access to such Agent's Collections, Boards and Assets; and (iii) a centrally-located region for co-authoring Boards.

### Duel Login

Customer and an Agent to simultaneously login to the system and access certain functionality of the Agent Subsystem collaboratively

### Import Retailer Collections

An Agent can access and display Retailer Collections using standard user interface techniques, such as text entry, control interaction (e.g., button tapping), dragging, etc. For example, an Agent may display a particular store location's complete Product Inventory (as evidenced by a Retailer Collection created by an Administrator for this purpose) or a sale items Product list, etc.

### Create Board

To create a Board, an Agent or a Customer initiates the Board creation process, for example by tapping a button, then inputs a name for the newly-created Board. The Agent or Customer may also optionally input any number of Tags to further define the Board. Upon creation, a Board is loaded into the centrally-located region for co-authoring of Boards.

### Load Board

An Agent or a Customer may load a previously-created Board into the centrally-located region for co-authoring Boards, for example by tapping a button.

### Edit Board

An Agent or a Customer may add, edit or delete Assets and Tags and rearrange Assets with respect to a Board loaded into the centrally-located region for co-authoring Boards. These actions are effectuated using standard user interface techniques, such as text entry, control interaction (e.g., button tapping), dragging, etc.

### Delete Board

To delete a Board, an Agent or a Customer initiates the Board deletion process, for example by clicking a button. Upon doing so, the Board is removed from the Customer Subsystem (i.e., Boards created in the Large Format Agent Subsystem Embodiment are generally available through the Customer Subsystem as they are owned by a Customer).

### Add Asset to Board

To add an Asset to a first Board an Agent or a Customer first locates the Asset in such a System User's second Board or Collection, then initiates the Asset copy process, for example by dragging such Asset into the first Board. Upon doing so, a copy of the Asset and any associated Asset Descriptors is added to the first Board. Once added to the first Board, the Agent or Customer may modify the location of the Asset on the first Board.

### Copy Collection

A System User may drag an entire Collection from such System User's work area to the other User's work area, thereby copying such Collection into such other System User's account.

### Copy Board

A System User may drag an entire Board from such System User's work area to the other User's work area, thereby copying such Board into such other System User's account.

### Copy Asset

A System User may drag an Asset from such System User's work area to the other User's work area, thereby copying such Board into such other System User's account.

### Mobile Agent Subsystem

In the preferred embodiment of the Mobile Agent Subsystem, the Mobile Agent Subsystem allows for the following functions:

### Create Collection

To create a Collection, an Agent initiates the Collection creation process, for example by tapping a button, then inputting a name for the newly-created Collection. The Agent may also optionally input any number of Tags to further define the Collection.

### Edit Collection

An Agent may add, edit or delete Assets and Tags and reorder Assets. These actions are effectuated using standard user interface techniques, such as text entry, control interaction (e.g., button tapping), dragging, etc.

### Delete Collection

To delete a Collection, an Agent initiates the Collection deletion process, for example by tapping a button. Upon doing so, the Collection and its Assets are removed from the Agent Subsystem. However, if the same Assets appear in other Collections, these Assets will remain in such other Collections.

### View Collection

An Agent may select and view a Collection using standard user interface techniques, such as text entry, control interaction (e.g., button tapping), dragging, etc. When viewing a Collection, an Agent primarily views/interacts with Assets within such Collection.

### Share Collection

To publish a Collection to a third party network such as FACEBOOK, thereby sharing the contents of the Collection with other individuals, an Agent initiates the Collection publication process, for example by tapping a button. Upon doing so, the Collection, including its name, Tags, Assets and Asset Descriptors, is published to a third party network. Publishing a Collection requires interoperability between the Agent Subsystem and a third party network following the connection means made available by such third party network and requiring Agent approvals and inputs as necessary to effectuate the transfer of data.

### View Board

An Agent may select and view a Board using standard user interface techniques, such as text entry, control interaction (e.g., button tapping), dragging, etc.

### Delete Board

To delete a Board, an Agent initiates the Board deletion process, for example by tapping a button. Upon doing so, the Board is removed from the Agent Subsystem.

### Share Board

To publish a Board to a third party network such as FACEBOOK, thereby sharing the contents of the Board with other individuals, an Agent initiates the Board publication process, for example by tapping a button. Upon doing so, the Board, including its name, Tags, Assets and Asset Descriptors, is published to a third party network. Publishing a Board requires interoperability between the Agent Subsystem and a third party network following the connection means made available by such third party network and requiring Agent approvals and inputs as necessary to effectuate the transfer of data.

### Add Image Asset Using Device Camera

To acquired an image Asset using the camera incorporated into the device used to operate the Mobile Agent Subsystem Embodiment then add that Asset to a Collection, an Agent activates the device camera, for example by tapping a button, then acquires that Asset following standard procedures for doing so with such device. Once the Asset is so acquired, the Asset is added to the Collection designated by the Agent. By default, each new Asset is added to a Collection after the last most recently added Asset.

Add Asset to Collection from External Source

To add an Asset to a Collection, an Agent locates an Asset that is either locally available on the device used to operate the Mobile Customer Subsystem Embodiment or available over a network, including the Internet, then initiates the Asset acquisition process, for example by tapping a button. Upon doing so, the Asset is added to the Collection designated by the Agent. By default, each new Asset is added to a Collection after the last most recently added Asset.

Copy Asset from Collection

To add an Asset to a Collection when that Asset already exists in another Collection, an Agent locates the Asset in such other Collection, then initiates the Asset copy process, for example by tapping a button. Upon doing so, a copy of the Asset and any associated Asset Descriptors is added to the Collection designated by the Agent. By default, each copied Asset is added to a Collection after the last most recently added Asset.

### Bulk Import of Assets to Collection

To import more than one Asset into a Collection at a time, an Agent identifies a data structure administered and/or hosted by a third party service, such as a FACEBOOK album, a PINTEREST pinboard, an ITUNES playlist, a YOUTUBE playlist or FLICKR album, that contains Assets and that such Agent has access rights to then initiates the Asset import process, for example by tapping a button. Upon doing so, data items associable with Assets and Asset Descriptors are associated with these Asset structures, respectively. Importing Assets requires interoperability between the Agent Subsystem and a third party network following the connection means made available by such third party network and requiring Agent approvals and inputs as necessary to effectuate the transfer of data.

### Edit Asset

An Agent may add, edit or delete Asset Descriptors. These actions are effectuated using standard user interface techniques, such as text entry, control interaction (e.g., button tapping), dragging, etc. These actions only affect the copy of an Asset associated with the Collection through which it is accessed. Other copies of an edited Asset are not affected.

### Delete Asset

To delete an Asset, an Agent initiates the Asset deletion process, for example by tapping a button. Upon doing so, the Asset is removed from its Collection. This action only affects the copy of an Asset associated with the Board or Collection through which it is accessed. Other copies of a deleted Asset are not affected.

### Share Asset

To publish an Asset to a third party network such as FACEBOOK, thereby sharing the Asset with other individuals, an Agent initiates the Asset publication process, for example by tapping a button. Upon doing so, the Asset, including its Asset Descriptors, is published to a third party network. Publishing an Asset requires interoperability between the Agent Subsystem and a third party network following the connection means made available by such third party network and requiring Agent approvals and inputs as necessary to effectuate the transfer of data.

### Add Asset Descriptors

An Agent may optionally input one or more Asset Descriptors to name or identify an Asset.

Associate Asset Descriptors with Regions of Image Assets

When the Asset is an image, an Agent may associate an Asset Descriptor to a region of that image by using available input means to designate such region, for example using the drag gesture with a mouse to mark a rectangular area of the image.

Associate Asset Descriptors with Identified Objects within Image Assets

When the Asset is an image, the Agent Subsystem may automatically identify objects within the Asset by circumscribing identified objects in a manner that visually highlights these objects and providing an Asset Descriptor for each such object. The Agent may accept, edit or delete such Asset Descriptors.

### Edit Asset Descriptor

An Agent may edit or delete an Asset Descriptor. These actions are effectuated using standard user interface techniques, such as text entry, control interaction (e.g., button tapping), dragging, etc.

### Delete Asset Descriptor

To delete an Asset Descriptor, an Agent initiates the Asset Descriptor deletion process, for example by tapping a button. Upon doing so, the Asset Descriptor is removed from its Asset.

### Share Asset

To publish an Asset to a third party network such as FACEBOOK, thereby sharing the Asset and associated Asset Descriptors with other individuals, an Agent initiates the Asset publication process, for example by tapping a button. Upon doing so, the Asset, including its Asset Descriptors, is published to a third party network. Publishing an Asset requires interoperability between the Agent Subsystem and a third party network following the connection means made available by such third party network and requiring Agent approvals and inputs as necessary to effectuate the transfer of data.

### Display Products for Collection

An Agent can navigate from a Collection, for example by tapping a button, to a list displaying Products that are determined by the Agent Subsystem to be related to such Collection. Such determination is made by comparing Tags and Asset Descriptors with information associated with Products. A Product may so be displayed by virtue of: (i) the name of, or Keywords associated with such, Product matching the content or meaning (as determined by the System) of one or more Tags or Asset Descriptors; (ii) the name of, or Keywords associated with such, Product being complementary to the content or meaning (as determined by the System) of one or more Tags or Asset Descriptors; or (iii) any other association or associations made by an Administrator using the Administrator Subsystem between such Product and Keywords entered by such Administrator that match the content or meaning (as determined by the System) of one or more Tags or Asset Descriptors.

### Display Products for Board

An Agent can navigate from a Board, for example by tapping a button, to a list displaying Products that are determined by the Agent Subsystem to be related to such Board. Such determination is made by comparing Tags and Asset Descriptors with information associated with Products. A Product may so be displayed by virtue of: (i) the name of, or Keywords associated with such, Product matching the content or meaning (as determined by the System) of one or more Tags or Asset Descriptors; (ii) the name of, or Keywords associated with such, Product being complementary to the content or meaning (as determined by the System) of one or more Tags or Asset Descriptors; or (iii) any other association or associations made by an Administrator using the Administrator Subsystem between such Product and Keywords entered by such Administrator that match the content or meaning (as determined by the System) of one or more Tags or Asset Descriptors.

### Display Products for Asset

When viewing/interacting with an Asset within a Collection or Board, an Agent can navigate from such Asset, for example by tapping a button, to a list displaying Products that are determined by the Agent Subsystem to be related to such Asset. Such determination is made by comparing Asset Descriptors with information associated with Products. A Product may so be displayed by virtue of: (i) the name of, or Keywords associated with such, Product matching the content or meaning (as determined by the System) of one or more Asset Descriptors; (ii) the name of, or Keywords associated with such, Product being complementary to the content or meaning (as determined by the System) of one or more Asset Descriptors; or (iii) any other association or associations made by an Administrator using the Administrator Subsystem between such Product and keywords entered by such Administrator that match the content or meaning (as determined by the System) of one or more Asset Descriptors.

### Customer Subsystem

The Customer Subsystem has two preferred embodiments, the Standard Customer Subsystem Embodiment and the Mobile Customer Subsystem Embodiment.

Various embodiments of the Agent Subsystem allow for the following functions which allow agents to:
(1) Create, update, delete and view Collections;
(2) Publish Collections to third-party social networks such as FACEBOOK for the purpose of sharing Collections with others;
(3) Create, update, delete and view Boards;
(4) Publish Boards to third-party social networks such as FACEBOOK for the purpose of sharing Boards with others; and
(5) Identify and purchase Products.

### Standard Customer Subsystem

In the preferred embodiment of the Standard Customer Subsystem, the Standard Customer Subsystem allows for the following functions:

### Create Collection

To create a Collection, a Customer initiates the Collection creation process, for example by clicking a button, then inputs a name for the newly-created Collection. The Customer may also optionally input any number of Tags to further define the Collection.

Import Collection from Third Party Originator

To import a Collection, a Customer identifies a comparable data structure administered and/or hosted by a third party service, such as a FACEBOOK album, a PINTEREST pinboard, an ITUNES playlist, a YOUTUBE playlist or FLICKR album, that such Customer has access rights to then initiates the Collection import process, for example by clicking a button. Upon doing so, data items associable with Collection name, Assets, Tags and Asset Descriptors are associated with these Collection structures, respectively. Importing a Collection requires interoperability between the Customer Subsystem and a third party network following the connection means made available by such third party network and requiring Customer approvals and inputs as necessary to effectuate the transfer of data.

### Bookmark Shared Collection

Shared Collections that appear on third party networks include hyperlinks encoded in HTML. If a first Customer follows a hyperlink from a third party network included with the shared Collection of a second Agent or Customer, the first Customer will have the option of “bookmarking” such shared Collection of the second Agent or Customer such that the first Customer can view the second Agent's or Customer's Collection from within the Customer Subsystem as it appears to the first Customer (i.e., as if the Collection had been created by the first Customer). Access rights to such Collection with respect to the first Customer is limited to viewing only. If the second Agent or Customer deletes such Collection, the Collection will be removed from the first Customer's Customer Subsystem unless the first Customer elects to create a new Collection and copy all Assets into such Collection upon being prompted with the option to do so.

### Edit Collection

A Customer may add, edit or delete Assets and Tags and reorder Assets. These actions are effectuated using standard user interface techniques, such as text entry, control interaction (e.g., button clicking), dragging, etc.

### Delete Collection

To delete a Collection, a Customer initiates the Collection deletion process, for example by clicking a button. Upon doing so, the Collection and its Assets are removed from the Customer Subsystem. However, if the same Assets appear in other Collections, these Assets will remain in such other Collections.

### View Collection

A Customer may select and view a Collection using standard user interface techniques, such as text entry, control interaction (e.g., button clicking), dragging, etc. When viewing a Collection, a Customer primarily views/interacts with Assets within such Collection.

### Share Collection

To publish a Collection to a third party network such as FACEBOOK, thereby sharing the contents of the Collection with other individuals, a Customer initiates the Collection publication process, for example by clicking a button. Upon doing so, the Collection, including its name, Tags, Assets and Asset Descriptors, is published to a third party network. Publishing a Collection requires interoperability between the Customer Subsystem and a third party network following the connection means made available by such third party network and requiring Customer approvals and inputs as necessary to effectuate the transfer of data.

### Create Board

To create a Board, a Customer initiates the Board creation process, for example by clicking a button, then inputs a name for the newly-created Board. The Customer may also optionally input any number of Tags to further define the Board.

### Edit Board

A Customer may add, edit or delete Assets and Tags and rearrange Assets. These actions are effectuated using standard user interface techniques, such as text entry, control interaction (e.g., button clicking), dragging, etc.

### Delete Board

To delete a Board, a Customer initiates the Board deletion process, for example by clicking a button. Upon doing so, the Board is removed from the Customer Subsystem.

### View Board

A Customer may select and view a Board using standard user interface techniques, such as text entry, control interaction (e.g., button clicking), dragging, etc.

### Share Board

To publish a Board to a third party network such as FACEBOOK, thereby sharing the contents of the Board with other individuals, a Customer initiates the Board publication process, for example by clicking a button. Upon doing so, the Board, including its name, Tags, Assets and Asset Descriptors, is published to a third party network. Publishing a Board requires interoperability between the Customer Subsystem and a third party network following the connection means made available by such third party network and requiring Customer approvals and inputs as necessary to effectuate the transfer of data.

Add Asset to Collection from External Source

To add an Asset to a Collection, a Customer locates an Asset that is either locally available on the device used to operate the Standard Customer Subsystem Embodiment or available over a network, including the Internet, then initiates the Asset acquisition process, for example by clicking a button. Upon doing so, the Asset is added to the Collection designated by the Customer. By default, each new Asset is added to a Collection after the last most recently added Asset.

Copy Asset from Collection or Wish List

To add an Asset to a Collection when that Asset already exists in another Collection or the Wish List (when such Asset is an Asset associated with a Product), a Customer locates the Asset in such other Collection or the Wish List, then initiates the Asset copy process, for example by clicking a button. Upon doing so, a copy of the Asset and any associated Asset Descriptors is added to the Collection designated by the Customer. By default, each copied Asset is added to a Collection after the last most recently added Asset.

### Bulk Import of Assets to Collection

To import more than one Asset into a Collection at a time, a Customer identifies a data structure administered and/or hosted by a third party service, such as a FACEBOOK album, a PINTEREST pinboard, an ITUNES playlist, a YOUTUBE playlist or FLICKR album, that contains Assets and that such Customer has access rights to then initiates the Asset import process, for example by clicking a button. Upon doing so, data items associable with Assets and Asset Descriptors are associated with these Asset structures, respectively. Importing Assets requires interoperability between the Customer Subsystem and a third party network following the connection means made available by such third party network and requiring Customer approvals and inputs as necessary to effectuate the transfer of data.

### Add Asset to Board

To add an Asset to a Board a Customer first locates the Asset in a Collection or the Wish List (when such Asset is an Asset associated with a Product), then initiates the Asset copy process, for example by clicking a button. Upon doing so, a copy of the Asset and any associated Asset Descriptors is added to the Board designated by the Customer. Once added to the Board, the Customer may modify the location of the Asset on the Board.

### Edit Asset

A Customer may add, edit or delete Asset Descriptors. These actions are effectuated using standard user interface techniques, such as text entry, control interaction (e.g., button clicking), dragging, etc. These actions only affect the copy of an Asset associated with the Board or Collection through which it is accessed. Other copies of an edited Asset are not affected.

### Delete Asset

To delete an Asset, a Customer initiates the Asset deletion process, for example by clicking a button. Upon doing so, the Asset is removed from its Collection. This action only affects the copy of an Asset associated with the Board or Collection through which it is accessed. Other copies of a deleted Asset are not affected.

### Share Asset

To publish an Asset to a third party network such as FACEBOOK, thereby sharing the Asset with other individuals, a Customer initiates the Asset publication process, for example by clicking a button. Upon doing so, the Asset, including its Asset Descriptors, is published to a third party network. Publishing an Asset requires interoperability between the Customer Subsystem and a third party network following the connection means made available by such third party network and requiring Customer approvals and inputs as necessary to effectuate the transfer of data.

### Add Asset Descriptors

A Customer may optionally input one or more Asset Descriptors to name or identify an Asset.

Associate Asset Descriptors with Regions of Image Assets

When the Asset is an image, a Customer may associate an Asset Descriptor to a region of that image by using available input means to designate such region, for example using the drag gesture with a mouse to mark a rectangular area of the image.

Associate Asset Descriptors with Identified Objects within Image Assets

When the Asset is an image, the Customer Subsystem may automatically identify objects within the Asset by circumscribing identified objects in a manner that visually highlights these objects and providing an Asset Descriptor for each such object. The Customer may accept, edit or delete such Asset Descriptors.

### Edit Asset Descriptor

A Customer may edit or delete an Asset Descriptor. These actions are effectuated using standard user interface techniques, such as text entry, control interaction (e.g., button clicking), dragging, etc.

### Delete Asset Descriptor

To delete an Asset Descriptor, a Customer initiates the Asset Descriptor deletion process, for example by clicking a button. Upon doing so, the Asset Descriptor is removed from its Asset.

### Share Asset

To publish an Asset to a third party network such as FACEBOOK, thereby sharing the Asset and associated Asset Descriptors with other individuals, a Customer initiates the Asset publication process, for example by clicking a button. Upon doing so, the Asset, including its Asset Descriptors, is published to a third party network. Publishing an Asset requires interoperability between the Customer Subsystem and a third party network following the connection means made available by such third party network and requiring Customer approvals and inputs as necessary to effectuate the transfer of data.

Display Products for Collection

A Customer can navigate from a Collection, for example by clicking a button, to a list displaying Products that are determined by the Customer Subsystem to be related to such Collection. Such determination is made by comparing Tags and Asset Descriptors with information associated with Products. A Product may so be displayed by virtue of: (i) the name of, or Keywords associated with such, Product matching the content or meaning (as determined by the System) of one or more Tags or Asset Descriptors; (ii) the name of, or Keywords associated with such, Product being complementary to the content or meaning (as determined by the System) of one or more Tags or Asset Descriptors; or (iii) any other association or associations made by an Administrator using the Administrator Subsystem between such Product and Keywords entered by such Administrator that match the content or meaning (as determined by the System) of one or more Tags or Asset Descriptors.

### Display Products for Board

A Customer can navigate from a Board, for example by clicking a button, to a list displaying Products that are determined by the Customer Subsystem to be related to such Board. Such determination is made by comparing Tags and Asset Descriptors with information associated with Products. A Product may so be displayed by virtue of: (i) the name of, or Keywords associated with such, Product matching the content or meaning (as determined by the System) of one or more Tags or Asset Descriptors; (ii) the name of, or Keywords associated with such, Product being complementary to the content or meaning (as determined by the System) of one or more Tags or Asset Descriptors; or (iii) any other association or associations made by an Administrator using the Administrator Subsystem between such Product and Keywords entered by such Administrator that match the content or meaning (as determined by the System) of one or more Tags or Asset Descriptors.

### Display Products for Asset

When viewing/interacting with an Asset within a Collection or Board, a Customer can navigate from such Asset, for example by clicking a button, to a list displaying Products that are determined by the Customer Subsystem to be related to such Asset. Such determination is made by comparing Asset Descriptors with information associated with Products. A Product may so be displayed by virtue of: (i) the name of, or Keywords associated with such, Product matching the content or meaning (as determined by the System) of one or more Asset Descriptors; (ii) the name of, or Keywords associated with such, Product being complementary to the content or meaning (as determined by the System) of one or more Asset Descriptors; or (iii) any other association or associations made by an Administrator using the Administrator Subsystem between such Product and keywords entered by such Administrator that match the content or meaning (as determined by the System) of one or more Asset Descriptors.

### Add Product to Wish List

When viewing a list of Products, a Customer can cause the addition, for example by clicking a button, of such Product to the Wish List.

Delete Product from Wish List

To delete a Product from the Wish List, a Customer initiates the Product deletion process, for example by clicking a button. Upon doing so, the Product is removed from the Wish List. This action only affects the Product as it appears on the Wish List. Any Assets derived from such deleted Product that have been copied to a Collection or Board are not affected.

### Share Wish List

To publish the Wish List to a third party network such as FACEBOOK, thereby sharing the Wish List with other individuals, a Customer initiates the Wish List publication process, for example by clicking a button. Upon doing so, the Wish List is published to a third party network. Publishing the Wish List requires interoperability between the Customer Subsystem and a third party network following the connection means made available by such third party network and requiring Customer approvals and inputs as necessary to effectuate the transfer of data.

### Purchase Product

Products displayed in the Wish List optionally include hyperlinks to purchase such Products through online retailers (i.e., not directly through the Customer Subsystem).

### Mobile Customer Subsystem

In the preferred embodiment of the Mobile Customer Subsystem, the Mobile Customer Subsystem allows for the following functions:

### Create Collection

To create a Collection, a Customer initiates the Collection creation process, for example by tapping a button, then inputs a name for the newly-created Collection. The Customer may also optionally input any number of Tags to further define the Collection.

### Edit Collection

A Customer may add, edit or delete Assets and Tags and reorder Assets. These actions are effectuated using standard user interface techniques, such as text entry, control interaction (e.g., button tapping), dragging, etc.

### Delete Collection

To delete a Collection, a Customer initiates the Collection deletion process, for example by tapping a button. Upon doing so, the Collection and its Assets are removed from the Customer Subsystem. However, if the same Assets appear in other Collections, these Assets will remain in such other Collections.

### View Collection

A Customer may select and view a Collection using standard user interface techniques, such as text entry, control interaction (e.g., button tapping), dragging, etc. When viewing a Collection, a Customer primarily views/interacts with Assets within such Collection.

### Share Collection

To publish a Collection to a third party network such as FACEBOOK, thereby sharing the contents of the Collection with other individuals, a Customer initiates the Collection publication process, for example by tapping a button. Upon doing so, the Collection, including its name, Tags, Assets and Asset Descriptors, is published to a third party network. Publishing a Collection requires interoperability between the Customer Subsystem and a third party network following the connection means made available by such third party network and requiring Customer approvals and inputs as necessary to effectuate the transfer of data.

### View Board

A Customer may select and view a Board using standard user interface techniques, such as text entry, control interaction (e.g., button tapping), dragging, etc.

### Delete Board

To delete a Board, a Customer initiates the Board deletion process, for example by tapping a button. Upon doing so, the Board is removed from the Customer Subsystem.

### Share Board

To publish a Board to a third party network such as FACEBOOK, thereby sharing the contents of the Board with other individuals, a Customer initiates the Board publication process, for example by tapping a button. Upon doing so, the Board, including its name, Tags, Assets and Asset Descriptors, is published to a third party network. Publishing a Board requires interoperability between the Customer Subsystem and a third party network following the connection means made available by such third party network and requiring Customer approvals and inputs as necessary to effectuate the transfer of data.

### Add Image Asset Using Device Camera

To acquired an image Asset using the camera incorporated into the device used to operate the Mobile Customer Subsystem Embodiment then add that Asset to a Collection, a Customer activates the device camera, for example by tapping a button, then acquires that Asset following standard procedures for doing so with such device. Once the Asset is so acquired, the Asset is added to the Collection designated by the Customer. By default, each new Asset is added to a Collection after the last most recently added Asset.

Add Asset to Collection from External Source

To add an Asset to a Collection, a Customer locates an Asset that is either locally available on the device used to operate the Mobile Customer Subsystem Embodiment or available over a network, including the Internet, then initiates the Asset acquisition process, for example by tapping a button. Upon doing so, the Asset is added to the Collection designated by the Customer. By default, each new Asset is added to a Collection after the last most recently added Asset.

Copy Asset from Collection or Wish List

To add an Asset to a Collection when that Asset already exists in another Collection or the Wish List (when such Asset is an Asset associated with a Product), a Customer locates the Asset in such other Collection or the Wish List, then initiates the Asset copy process, for example by tapping a button. Upon doing so, a copy of the Asset and any associated Asset Descriptors is added to the Collection designated by the Customer. By default, each copied Asset is added to a Collection after the last most recently added Asset.

### Bulk Import of Assets to Collection

To import more than one Asset into a Collection at a time, a Customer identifies a data structure administered and/or hosted by a third party service, such as a FACEBOOK album, a PINTEREST pinboard, an ITUNES playlist, a YOUTUBE playlist or FLICKR album, that contains Assets and that such Customer has access rights to then initiates the Asset import process, for example by tapping a button. Upon doing so, data items associable with Assets and Asset Descriptors are associated with these Asset structures, respectively. Importing Assets requires interoperability between the Customer Subsystem and a third party network following the connection means made available by such third party network and requiring Customer approvals and inputs as necessary to effectuate the transfer of data.

### Edit Asset

A Customer may add, edit or delete Asset Descriptors. These actions are effectuated using standard user interface techniques, such as text entry, control interaction (e.g., button tapping), dragging, etc. These actions only affect the copy of an Asset associated with the Collection through which it is accessed. Other copies of an edited Asset are not affected.

### Delete Asset

To delete an Asset, a Customer initiates the Asset deletion process, for example by tapping a button. Upon doing so, the Asset is removed from its Collection. This action only affects the copy of an Asset associated with the Board or Collection through which it is accessed. Other copies of a deleted Asset are not affected.

### Share Asset

To publish an Asset to a third party network such as FACEBOOK, thereby sharing the Asset with other individuals, a Customer initiates the Asset publication process, for example by tapping a button. Upon doing so, the Asset, including its Asset Descriptors, is published to a third party network. Publishing an Asset requires interoperability between the Customer Subsystem and a third party network following the connection means made available by such third party network and requiring Customer approvals and inputs as necessary to effectuate the transfer of data.

### Add Asset Descriptors

A Customer may optionally input one or more Asset Descriptors to name or identify an Asset.

Associate Asset Descriptors with Regions of Image Assets

When the Asset is an image, a Customer may associate an Asset Descriptor to a region of that image by using available input means to designate such region, for example using the drag gesture with a mouse to mark a rectangular area of the image.

Associate Asset Descriptors with Identified Objects within Image Assets

When the Asset is an image, the Customer Subsystem may automatically identify objects within the Asset by circumscribing identified objects in a manner that visually highlights these objects and providing an Asset Descriptor for each such object. The Customer may accept, edit or delete such Asset Descriptors.

### Edit Asset Descriptor

A Customer may edit or delete an Asset Descriptor. These actions are effectuated using standard user interface techniques, such as text entry, control interaction (e.g., button tapping), dragging, etc.

### Delete Asset Descriptor

To delete an Asset Descriptor, a Customer initiates the Asset Descriptor deletion process, for example by tapping a button. Upon doing so, the Asset Descriptor is removed from its Asset.

### Share Asset

To publish an Asset to a third party network such as FACEBOOK, thereby sharing the Asset and associated Asset Descriptors with other individuals, a Customer initiates the Asset publication process, for example by tapping a button. Upon doing so, the Asset, including its Asset Descriptors, is published to a third party network. Publishing an Asset requires interoperability between the Customer Subsystem and a third party network following the connection means made available by such third party network and requiring Customer approvals and inputs as necessary to effectuate the transfer of data.

### Display Products for Collection

A Customer can navigate from a Collection, for example by tapping a button, to a list displaying Products that are determined by the Customer Subsystem to be related to such Collection. Such determination is made by comparing Tags and Asset Descriptors with information associated with Products. A Product may so be displayed by virtue of: (i) the name of, or Keywords associated with such, Product matching the content or meaning (as determined by the System) of one or more Tags or Asset Descriptors; (ii) the name of, or Keywords associated with such, Product being complementary to the content or meaning (as determined by the System) of one or more Tags or Asset Descriptors; or (iii) any other association or associations made by an Administrator using the Administrator Subsystem between such Product and Keywords entered by such Administrator that match the content or meaning (as determined by the System) of one or more Tags or Asset Descriptors.

### Display Products for Board

A Customer can navigate from a Board, for example by tapping a button or other icon, to a list displaying Products that are determined by the Customer Subsystem to be related to such Board. Such determination is made by comparing Tags and Asset Descriptors with information associated with Products. A Product may so be displayed by virtue of: (i) the name of, or Keywords associated with such, Product matching the content or meaning (as determined by the System) of one or more Tags or Asset Descriptors; (ii) the name of, or Keywords associated with such, Product being complementary to the content or meaning (as determined by the System) of one or more Tags or Asset Descriptors; or (iii) any other association or associations made by an Administrator using the Administrator Subsystem between such Product and Keywords entered by such Administrator that match the content or meaning (as determined by the System) of one or more Tags or Asset Descriptors.

### Display Products for Asset

When viewing/interacting with an Asset within a Collection or Board, a Customer can navigate from such Asset, for example by tapping a button, to a list displaying Products that are determined by the Customer Subsystem to be related to such Asset. Such determination is made by comparing Asset Descriptors with information associated with Products. A Product may so be displayed by virtue of: (i) the name of, or Keywords associated with such, Product matching the content or meaning (as determined by the System) of one or more Asset Descriptors; (ii) the name of, or Keywords associated with such, Product being complementary to the content or meaning (as determined by the System) of one or more Asset Descriptors; or (iii) any other association or associations made by an Administrator using the Administrator Subsystem between such Product and keywords entered by such Administrator that match the content or meaning (as determined by the System) of one or more Asset Descriptors.

### Add Product to Wish List

When viewing a list of Products, a Customer can cause the addition, for example by tapping a button, of such Product to the Wish List.

Delete Product from Wish List

To delete a Product from the Wish List, a Customer initiates the Product deletion process, for example by tapping a button. Upon doing so, the Product is removed from the Wish List. This action only affects the Product as it appears on the Wish List. Any Assets derived from such deleted Product that have been copied to a Collection or Board are not affected.

### Share Wish List

To publish the Wish List to a third party network such as FACEBOOK, thereby sharing the Wish List with other individuals, a Customer initiates the Wish List publication process, for example by tapping a button. Upon doing so, the Wish List is published to a third party network. Publishing the Wish List requires interoperability between the Customer Subsystem and a third party network following the connection means made available by such third party network and requiring Customer approvals and inputs as necessary to effectuate the transfer of data.

### Purchase Product

Products displayed in the Wish List optionally include hyperlinks to purchase such Products through online retailers (i.e., not directly through the Customer Subsystem).

The preferred embodiment of the System facilitates a Customer/Agent interaction in a real world store. The System allows a customer to input data relating to Products and Assets obtained from the internet, for example, images or product information from third party websites or social media. The System also allows a Customer to input data that they have generated themselves, for example, pictures or homemade video. The System then allows the Agent to help the Customer obtain Products from the store based on these inputs by the Customer and the interaction with the Customer regarding these inputs.

The preferred embodiment, the System accomplishes this by providing the Agent with a database of the store's Products that are for sale and that has been optionally modified according to an Administrator. The System allows the Customer and Agent to then compare the Products of the store with the Products and Assets. For example, the Customer can identify, classify and annotated products and assest using the Customer Subsystem, which the Customer can access from the store (e.g., using the Mobile Customer Subsystem Embodiment). Many other subsystem functions, described above, also facilitate Customer/Agent interaction to product an output of the system.

In some embodiments, the Customer does not bring in any outside Product or Asset data, but can generate such data using the Product Database of the store in cooperation with the Agent.

In some embodiments, the System comprises

A. a memory storage device to receive and store, product and asset information from a product database that is specific to a point of sale location and customer input,

B. a processor that processes customer and agent input and produces an output wherein the output is a product from the product database,

C. an interactive display device capable of displaying the output.

In some embodiments, the Customer input is Product or Asset information.

In some embodiments, the Agent input is a search of the Product Database based on the Customer input.

In some embodiments, the system additionally acts as a point of sale for the output of the system.

In some embodiments, the method for selecting a Product comprises:

A. providing Customer input according to a function of a Customer Subsystem,

B. providing Agent input according to a function of an Agent Subsystem,

C. selecting a Product or Products from a Product Database according to Customer and Agent inputs,

D. displaying the selected Product or Products.

In some embodiments, the method additionally comprises,

E. modifying the Customer and Agent input according to Product or Products displayed,

F. selecting a Product from a Product Database according to the modified Customer and modified Agent input,

G. displaying the selected Product or Products.

In some embodiments, the method for selecting a Product comprises:

A. displaying Product and/or Asset data according to a Customer input in a first zone,

B. displaying Product data from a Product Database according to Agent input in a second zone,

C. processing the data in the first and second zones according to any functions of the Customer or Agent Subsystems to provide an output,

D. displaying Product information from the Product Database according to the output of the System in a third zone.

In some embodiments, the Product data displayed in a first zone is modified according to the Product data displayed in zone 3.

In some embodiments, the Product data displayed in a third zone is transmitted to a mobile communication device or a cloud.

In some embodiments, the method additionally includes transacting a sale of the product displayed in the third zone.

### BRIEF DESCRIPTION OF THE DRAWINGS

FIG. 1 is a flow chart showing the how data is processed in a preferred embodiment of the System.

FIG. 2 is a flow chart showing the how data is processed in another preferred embodiment of the System.

FIG. 3 is an example of a display of some embodiments of the system and method.

### DETAILED DESCRIPTION OF THE DRAWINGS

FIG. 1 is a flow chart showing the how data is processed in a preferred embodiment of the system. In this embodiment the product database (1) contains all the product data of the particular store which the system is located. The administrator can optionally provide input (4) to the product database (1) according to any the various administrative subsystems of the system. For example, the administrator input (4) can be labeling various products in the product database (1) with keywords. The system will then identify the product if a search for the keyword is performed.

In some embodiments, the Administrator may provide no input (4) to the product database.

In some embodiments, the administrator can provide input (4) according to any combination of administrator subsystems.

An agent provides input (3) to the system according to any of the various agent subsystems of the system. The products data available to the agent is limited to the product database (1).

A customer provides input (2) to the system according to any of the various customer subsystems of the system. The customer is not limited in databases from which product or asset data can be gathered.

The system takes action (5) according to the agent input (3) and the customer input (2) and produces an output (6).

In the preferred embodiment the output (6) is a product or products from the product database (1).

In some embodiments the system can act as a point of sale for the product that is the result of the output (6).

FIG. 2 is identical to the FIG. 1 except that a feed back loop is formed between output (6) and the customer input (2) and administrator input (4). In this embodiment the output (6) of the system provides input for the customer and agent which can cause them to modify their respective inputs (2 and 3) which can result in a different output (6). This loop may optionally continue until the customer and agent inputs (2 and 3) are not modified by the output (6), i.e., until the customer is satisfied.

FIG. 3 is an example of a display of some embodiments of the system and method. The display is divided up into three zones. The zones can be any size relative to the screen, for example, they can occupy from 10% to 80% of the screen or from 1% to 98% of the screen. In some embodiments the size of zones is adjustable by a customer or an agent.

The first zone (7) is designated for displaying customer input. The second zone (8) is designated for displaying agent input. The third zone (9) is designated for displaying the output of the system and method. In the preferred embodiment, the displayed units (10) in each zone are in the form of a product or asset data, for example, a picture of the product or representative symbol of a good or service.

In some embodiments, the display also includes various function windows that allow functions of the customer and agent subsystems to be performed, for example, a search window where and agent can enter search terms based on the customer input.

In some embodiments, display units can be moved back and forth from the second and third zones and from the third zone to the first zone.

In some embodiments, placing a display unit in the third zone results in an items price, location in the store, and other product information being displayed. In other embodiments, the items price, location in the store, and other product information is provided as a print out or sent to a mobile electronic communication device.

In some embodiments the system acts as a point of sale for products in the third zone.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

From the foregoing description, one skilled in the art can easily ascertain the essential characteristics of this invention and, without departing from the spirit and scope thereof, can make various changes and modifications of the invention to adapt it to various usages and conditions.

1. A system for selecting a product comprising:
A. a memory storage device to receive and store, product and asset information from a product database that is specific to a point of sale location and customer input,
B. a processor that processes customer and agent input and produces an output wherein the output is a product from the product database,
C. an interactive display device capable of displaying the output.

2. The system of claim 1 wherein customer input is product or asset information from a customer's electronic device.

3. The system of claim 1 wherein agent input is a search of the product database based on the customer input.

4. The system of claim 1 wherein the system additionally acts as a point of sale for the output of the system.

5. A method for selecting a product comprising:
A. providing customer input according to a function of a customer subsystem,
B. providing agent input according to a function of an agent subsystem,
C. selecting a product or products from a product database according to customer and agent inputs,
D. displaying the selected product or products.

6. A method of claim 5 wherein the method additionally comprises,
E. modifying the customer and agent input according to product or products displayed,
F. selecting a product from a product database according to the modified customer and modified agent input,
G. displaying the selected product or products.

7. A method for selecting a product comprising:
A. displaying product and/or asset data according to a customer input in a first zone,
B. displaying product data from a product database according to agent input in a second zone,
C. processing the data in the first and second zones according to at least one function of the customer or agent subsystems to provide an output,
D. displaying product information from the product database according to the output of the system in a third zone.

8. The method of claim 7 wherein the product data displayed in the first zone is modified according to the product data displayed in zone 3.

9. The method of claim 8 wherein the product data displayed in the third zone is transmitted to a mobile communication device or a cloud.

10. The method of claim 7 additionally comprising transacting a sale of the product displayed in the third zone.
